(19) United States
(12) Patent Application Publication
(10) Pub. No.: US 2003/0157221 A1
(43) Pub. Date: Aug. 21, 2003

(54) Food cones

(76) Inventor: Robert Sharman, Broadstairs (GB)

Correspondence Address: Edwin D. Schindler, Five Hirsch Avenue, P. O. Box 966, Coram, NY, 11727-0966, US

(21) Appl. No.: 10/079,140

(22) Filed: Feb. 19, 2002

(51) Int. Cl. A23G 3/00

(52) U.S. Cl. 426/91

(57) ABSTRACT

An insert for fitting into a food cone to form a platform, intermediate the top and bottom of the cone, to support the edible contents of the food cone. An upwardly-extending projection may be provided to help support the edible contents and inhibit them falling over.

### BACKGROUND OF THE INVENTION

The present invention relates to food cones and more particularly to inserts arranged to be used in food cones.

I have now devised inserts for food cones, which in use provide a number of advantages

### SUMMARY OF THE INVENTION

Thus, in accordance with the present invention, there is provided an insert for fitting into a food cone to form a platform, intermediate the top and bottom of the food cone, to support the contents of the food cone.

By providing such a platform at a level intermediate the top and bottom of the food cone, the insert serves to support the edible contents of the food cone and prevent them from sinking to the bottom of the food cone; this is a particular advantage in the case of ice cream or the like.

Preferably the insert comprises a flat base, which forms the supporting platform.

Preferably the insert includes an upstanding, peripheral rim which is frusto-conical in section, to seat against the inside surface of the food cone.

Preferably the insert is provided with a central, upwardly-extending projection, which in use helps to support the edible contents of the food cone and inhibit these contents from falling to one side or another. Preferably this projection extends to a level above the top of the food cone, when fitted into the latter. The projection may be formed integrally with the insert, or may comprise a separate piece which engages to the insert.

Conveniently, the upwardly-extending projection of the insert may be conical in form. Instead, it may be in the form of a vertical stem, which may be flat or of other form. The upper end of the projection may carry indicia or other markings, for example of an advertising or promotional nature, or may be in the form of a figure or character.

The upwardly-extending projection may be formed with a receptacle for a sauce, dip or the like. For example, the projection may be frusto-conical in form and house a receptacle (e.g. of generally cup-shape) the upper end or rim of which merges with the upper end of the frusto-conical projection of the insert. A further member, e.g. in the form of a figure or character or carrying indicia or markings, may be provided to fit into and project from the receptacle.

The insert may be formed of plastics material. Instead however, it may be formed of edible material, particularly chocolate.

### BRIEF DESCRIPTION OF THE DRAWINGS

Embodiments of the present invention will now be described by way of examples only and with reference to the accompanying drawings, in which:

FIG. 1 is a view of a food cone into which a first embodiment of insert in accordance with this invention is fitted;

FIG. 2 is a vertical section through the food cone and insert shown in FIG. 1;

FIG. 3 is a side view of the food cone and insert shown in FIG. 1 and 2;

FIG. 4 is a view of the food cone shown in FIGS. 1 to 3, into which a second embodiment of insert in accordance with this invention is fitted;

FIG. 5 is a vertical section through the food cone and insert shown in FIG. 4;

FIG. 6 is a side view of the food cone and insert shown in FIGS. 4 and 5;

FIG. 7 is a side view another food cone fitted with a third embodiment of insert in accordance with this invention;

FIG. 8 is a vertical section through the food cone and insert shown in FIG. 7;

FIG. 9 is a view of the food cone shown in FIGS. 1 to 3, fitted with a fourth embodiment of insert in accordance with the invention; and

FIG. 10 is a vertical section through the food cone and insert shown in FIG. 9.

### DETAILED DESCRIPTION OF THE PREFERRED EMBODIMENTS

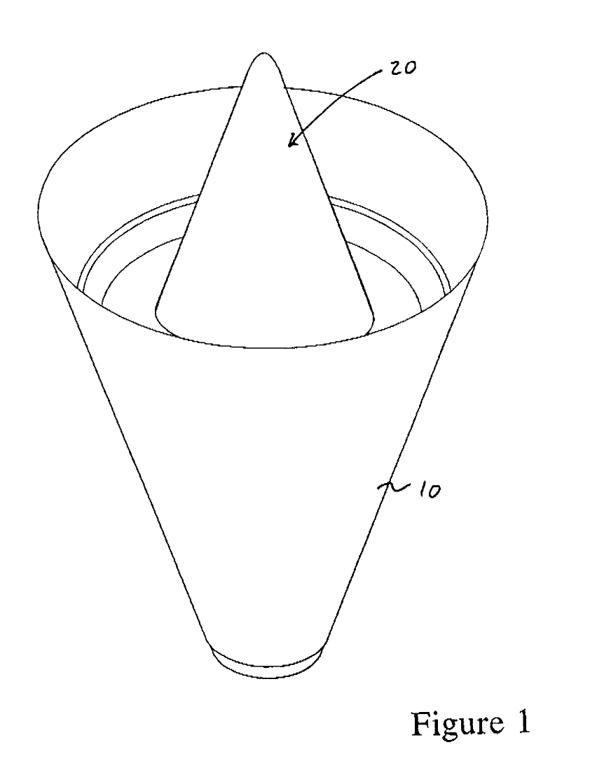

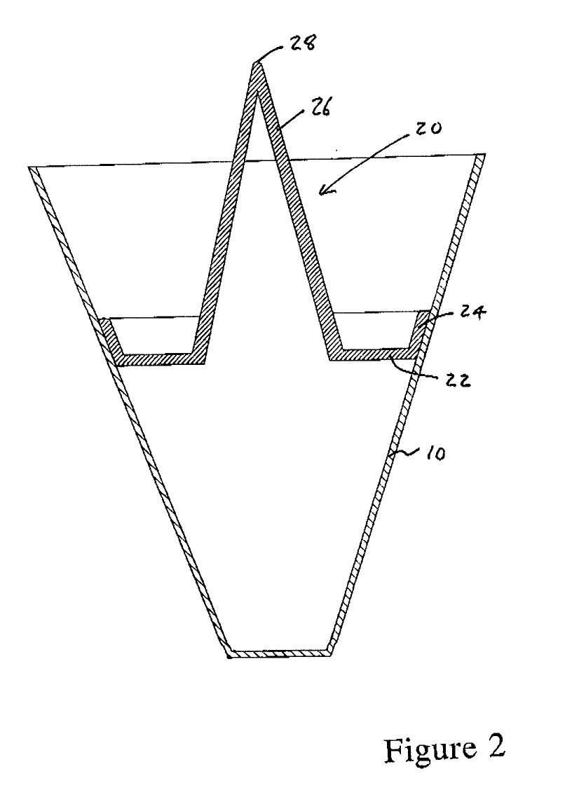

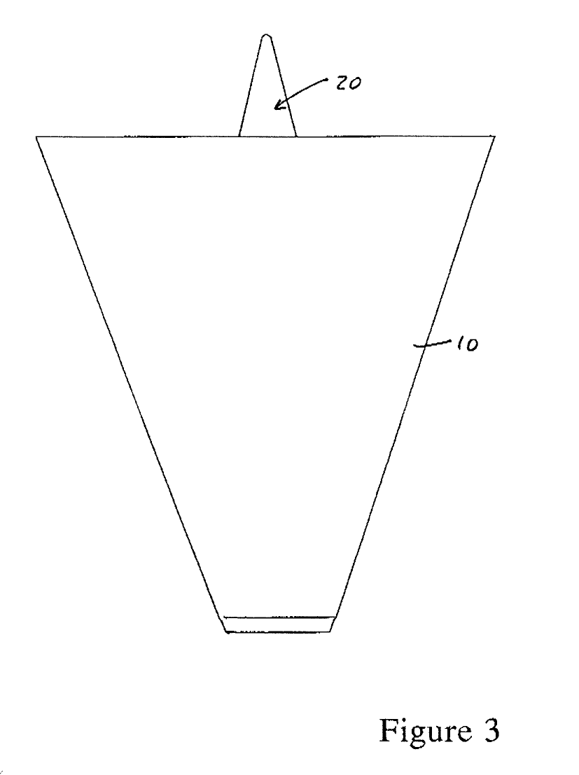

Referring to FIGS. 1 to 3 of the accompanying drawings, there is shown a receptacle 10 in the form of an inverted cone, or food cone, the lower, truncated end of which is closed and the upper, wider end of which is open. The food cone 10 may be of edible material, for example when intended to hold ice cream, or it may be of inedible material, for example when intended to hold french fries or popcorn.

In the example shown in FIGS. 1 to 3, an insert 20 is fitted into the food cone 10. The insert 20 comprises an annular, flat base 22 formed with an upwardly-projecting, peripheral rim 24 which is inclined to correspond to the conical inner surface of the food cone 10. The insert further comprises a central, conical portion 26 the lower end of which is joined to the inner periphery of the annular base 22: the conical portion 26 projects upwardly to a point 28 which is above the open top of the food cone 10. In the example shown, the insert 20 is formed in one-piece of plastics material.

In use, and as shown, the insert 20 is fitted into the open top of the food cone 10, to rest via its peripheral rim 24 against the inner surface of the food cone 10, at a level intermediate the top and bottom of the food cone. Ice cream or other food can then be placed in the food cone and is supported on the base 22 of the insert 20: in the case of ice cream in particular, this is then prevented from melting and sinking to the bottom of the food cone; further, the conical projection 26 of .the insert supports the ice cream above the food cone 10, such that the ice cream is less likely to fall to one side or another of the food cone.

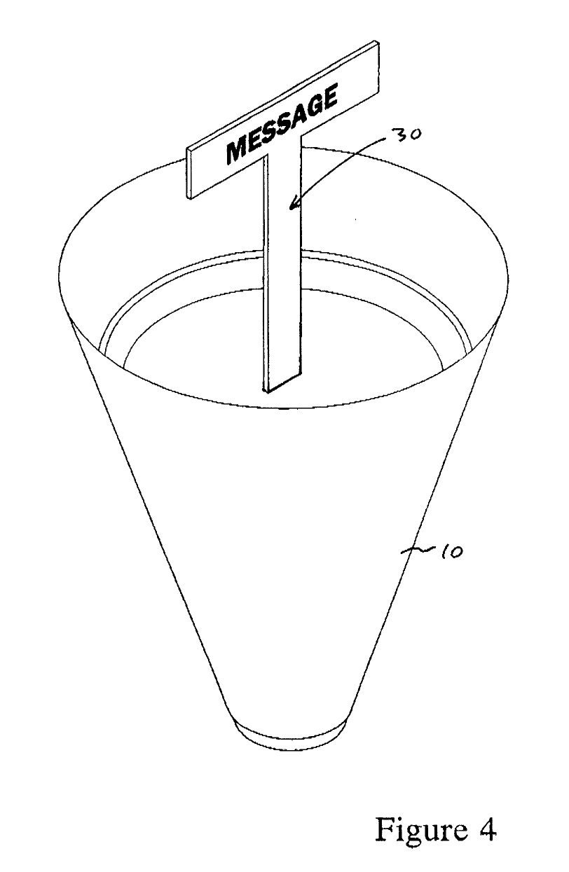

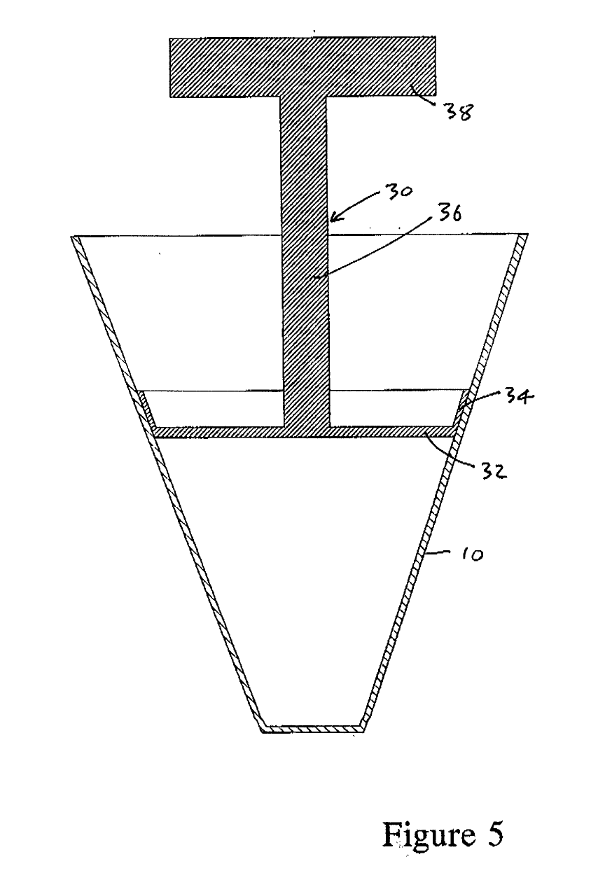

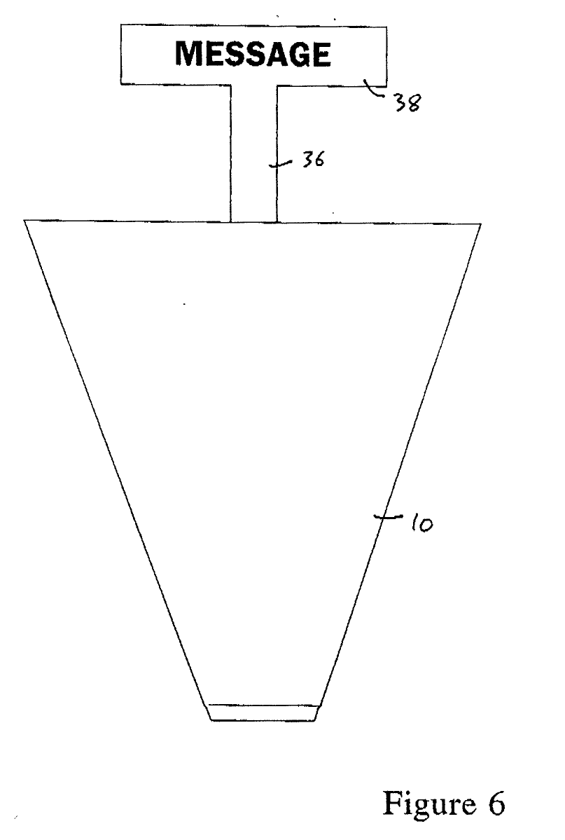

Referring to FIGS. 4 to 6 of the drawings, the same food cone 10 is shown, but with a modified insert 30 fitting into it. This insert 30 comprises a flat, circular base 32 having a peripheral rim 34 corresponding to the rim 24 of the insert 20 shown in FIG. 1 to 3: a stem 36 projects upwardly from the centre of the base 32, to a level above the top of the food cone 10; the stem 36 carries a cross-piece 38 at its top, which carries indicia in the form of information and/or advertising.

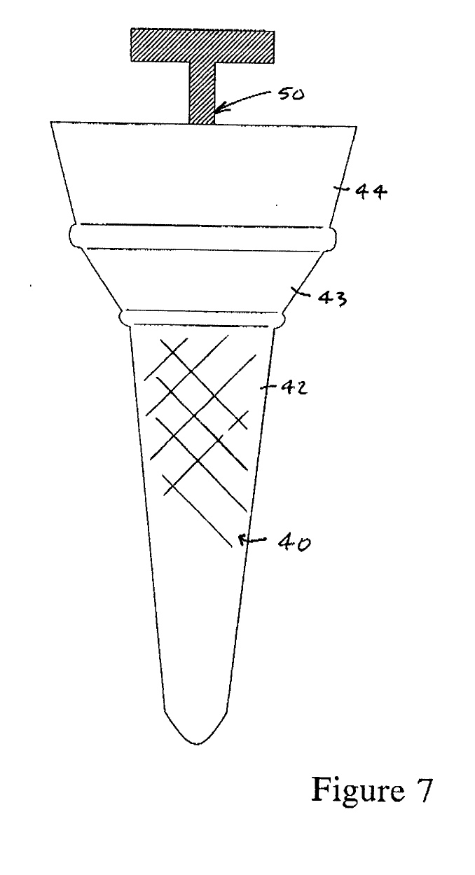

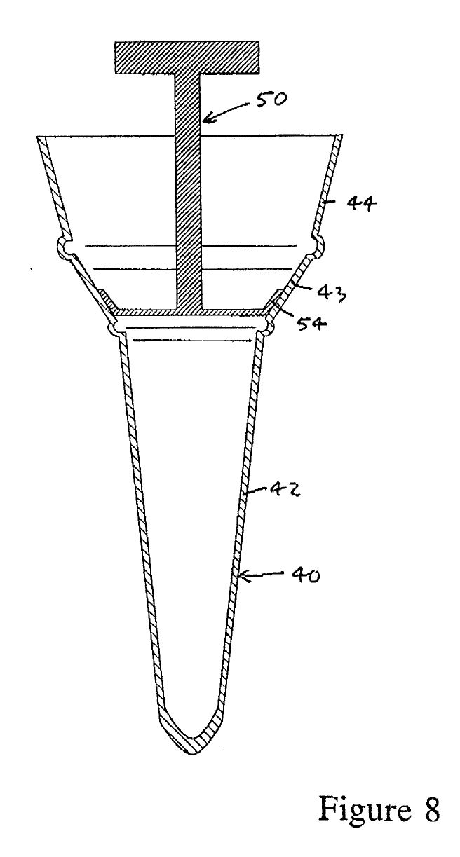

Referring to FIGS. 7 and 8 of the drawings, there is shown an ice cream cone 40 of more conventional style, which comprises a bottom portion 42 in the form of a cone of small cone angle, and a top portion which comprise a first conical section 43 of large cone angle and a second conical section 44 of intermediate cone angle. The cone 40 is shown with an insert 50 fitted into it: this insert corresponds to the insert 30 shown in FIGS. 4 to 6, except that its peripheral rim 54 lies on a cone of larger cone angle, to correspond with conical section 43 of the ice cream cone 40. It will be noted that the insert 50 seats within the cone 40 adjacent the bottom of the conical section 43.

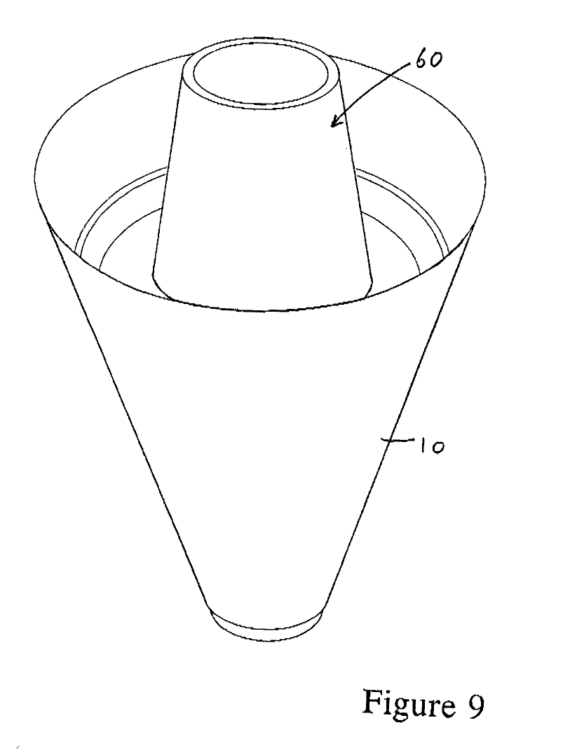

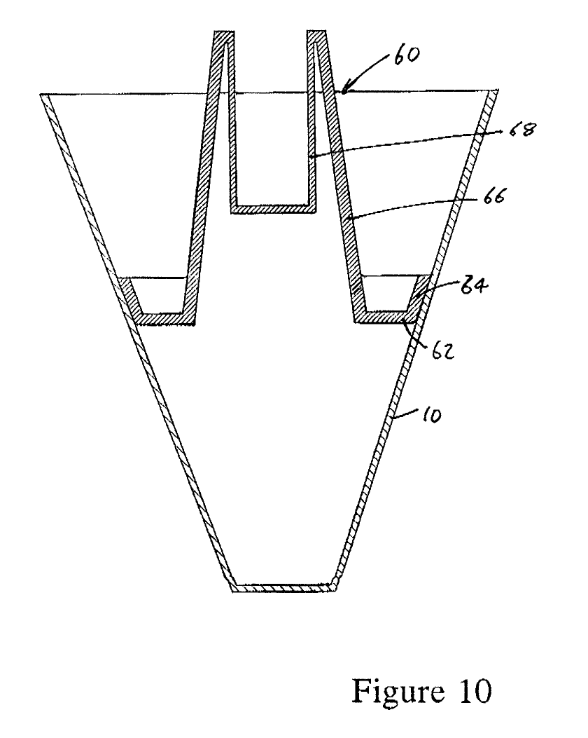

Referring to FIGS. 9 and 10 of the drawings, the food cone 10 of FIGS. 1 to 3 is shown, fitted with an insert 60 which has a central receptacle for containing a sauce or dip, for example. The insert 60 comprises a flat, annular base 62 formed with an upstanding, frusto-conical peripheral rim 64 for seating against the inner surface of the food cone 10. The insert 60 further comprises a central, frusto-conical portion 66, the lower end of which is joined to the inner periphery of the annular base 62: the upper end of the frusto-conical portion 66 merges with the upper end or rim of a cylindrical, cup-shaped receptacle 68, which is positioned within the frusto-conical portion 66. It will be noted that the frusto-conical portion 66 projects to a level above the top of the food cone 10, when fitted into the latter.

As previously mentioned, the inserts which have been shown and described may be formed of plastics material and may instead be formed in an edible material e.g. chocolate.

1) An insert for fitting into a food cone to form a platform, intermediate the top and bottom of the food cone, to support the contents of the food cone.

2) An insert as claimed in claim 1, comprising a flat base which forms said supporting platform,

3) An insert as claimed in claim 1, comprising an upstanding, peripheral rim which is frusto-conical in section, for seating against the inside surface of the food cone.

4) An insert as claimed in claim 1, comprising a central, upwardly-extending projection, for helping to support the edible contents of the food cone.

5) an insert as claimed in claim 4, in which said projection comprises a separate piece,

6) an insert as claimed in claim 4, in which said projection is conical in form:

7) An insert as claimed in claim 4, in which said projection is in the form of a vertical stem.

8) An insert as claimed in claim 4, in which the upper end of said projection carries indicia or other markings.

9) An insert as claimed in claim 4, in which the upper end of said projection is in the form of a figure or character.

10) An insert as claimed in claim 4, in which said projection is formed with a receptacle.

11) An insert as claimed in claim 4, in which a further member is provided to fit into said receptacle.
